(19) United States
(12) Patent Application Publication
(10) Pub. No.: US 2002/0049639 A1
(43) Pub. Date: Apr. 25, 2002

(54) Network sales system with settling server and seller server connected by the network not open to third party

(75) Inventors: Hisashi Tanaka, Tokyo (JP); Kazuhiko Tsukada, Tokyo (JP)

Correspondence Address: Paul J. Essatto, Jr., Scully, Scott, Murphy & Presser, 400 Garden City Plaza, Garden City, NY, 11530, US

(73) Assignee: NEC Corporation, Tokyo (JP)

(21) Appl. No.: 09/894,730

(22) Filed: Jun. 28, 2001

(30) Foreign Application Priority Data
Jun. 28, 2000 (JP) 2000-194978

(51) Int. Cl. G06F 17/60

(52) U.S. Cl. 705/26; 705/40

(57) ABSTRACT

A network sales system with a settling server and a seller server connected by a network open to third parties, is disclosed. A user terminal and the seller server are connected to each other by a first network, and the settling server and the seller server are connected to each other by a second network. The second network is not accessible from general user terminals. Important personal information such as a credit number of the user is transmitted and received over only the second network, and the settling server is connected only to the second network. Therefore, the credit information is prevented from being stolen by third parties, and unauthorized third parties are prevented from entering settling server. The network sales system thus has increased security.

### BACKGROUND OF THE INVENTION

1. Field of the Invention

The present invention relates to a network sales system and method for selling articles through the Internet, and more particularly to a network sales system and method characterized by a process of settling the payment of money for an article that has been purchased by a user.

2. Description of the Related Art

Network sales systems for selling articles through the Internet are finding more use in recent years. Users can enjoy online shopping on such a network sales system to purchase various articles without actually going to shops. A user who attempts to buy an article from a seller on such a network sales system operates the user terminal to connect via the Internet to a server which is being operated by the seller. The user then browses through the home page of the seller, chooses the article that the user wants to buy from a selection of articles offered for sale on the home page, and applies for the purchase of the article.

In the network sales system, the user is required to settle the payment of money for the article to the seller at the time of applying for the purchase of the article. The seller needs to dispatch the article after having confirmed the paying ability of the user, who is among unspecified persons, upon the application for the purchase of the article, because otherwise the seller might possibly be unable to collect the money. The network sales system employs various processes of settling the payment of money for articles that are sold. According to one process, the purchaser pays the money to the deliveryman upon delivery of the article. According to another process, the seller dispatches the article after having confirmed the transfer of the money from the purchaser to the bank account of the seller. According to still another process, the purchaser picks up the article and also pays the money at a suitable location such as a convenience store. These processes, however, are troublesome for the user and disrupt the convenience of the purchase of articles on the network sales system. There have been demands for safe processes of settling the payment of money for purchased articles on networks. One most general process that has been used today for settling the payment of money for purchased articles on networks is a credit sale process that is performed via a credit company.

One conventional network sales system for settling the payment of money for purchased articles on a network is shown in FIG. 1 of the accompanying drawings.

As shown in FIG. 1, the conventional network sales system comprises seller server 10, network 20 such as the Internet, user terminal 30, settling server 40, credit information database 50, and article database 60.

For the sake of brevity, it is assumed that there is only one user terminal in the network sales system. In the actual network sales system, a plurality of user terminals can be connected to seller server 10 via network 20.

Article database 60 is connected to seller server 10 and stores information of articles offered for sale and information of prices, etc., of the articles. User terminal 30 is operated by the user who wants to purchase an article, and can be connected to network 20. Seller server 10 is connected to network 20, provides information of articles stored in article database 60 to user terminal 30, and receives an application for the purchase of an article from user terminal 30.

Credit information database 50 stores credit information of each user that represents a present credit payment status, a debt status for credit payment, a limit amount of money available for credit sale, a past history of payments, and an expiration date, which are used to determine whether an application for the purchase of an article is to be accepted or not.

Settling server 40 is installed in a credit company or the like. When requested by seller server 40 to refer to credit information, settling server 40 checks the transmitted information against the credit information stored in credit information database 50 to determine whether a credit sale is approved or not. If settling server 40 approves the credit sale, then settling server 40 transmits an approval notice to seller server 10.

Operation of the conventional network sales system will be described below with reference to a sequence chart shown in FIG. 2 of the accompanying drawings.

First, the user operates user terminal 30 to connect to seller server 10 via network 20, chooses an article which the user wants to purchase, and applies for the purchase of the chosen article together with the transmission of information indicating the credit number, the name, the date of birth, etc., in step 301.

In response to the application for the purchase from user terminal 30, seller server 10 transmits information indicating the amount of money to be paid for the article, the name of the user, the credit number, etc., via network 20 to settling server 40 to request settling server 40 to check the credit information in step 302.

Requested by seller server 10 to check the credit information, settling server 40 checks the transmitted credit information against the information stored in credit information database 50 to determine whether a credit sale is to be approved or not. If a credit sale is to be approved, then settling server 40 transmits an approval notice to seller server 10 in step 303.

When supplied with the approval notice from settling server 40, seller server 10 sends a purchase acceptance notice to user terminal 30 in step 304. The article will subsequently be delivered to an address that has been indicated by the user upon the application for the purchase of the article.

If settling server 40 does not approve a credit sale based on the credit information sent from seller server 10, then settling server 40 transmits a non-approval notice to seller server 10, which transmits a purchase rejection notice to user terminal 30.

In another conventional network sales system disclosed in published Japanese translation of PCT international publication No. 10-509543 (U.S. Pat. No. 5,715,314), in order to reduce the processing burden on seller server 10, user terminal 30 directly requests settling server 40 to check credit information, and applies for the purchase of an article after having received an approval notice from settling server 40. The disclosed conventional network sales system has a system arrangement that is identical to the system arrangement shown in FIG. 1, and has a different settling process.

Operation of the disclosed conventional network sales system will be described below with reference to a sequence chart shown in FIG. 3 of the accompanying drawings.

First, the user operates user terminal 30 to connect to seller server 10 via network 20, and chooses an article which the user wants to purchase. Then, in step 401, the user operates the user terminal 30 to connect to settling server 40 via the network 20, transmits information of the chosen article and information of its price, together with information of the credit number, etc., to settling server 40 to request settling server 40 to check the credit information.

Requested by user terminal 30 to check the credit information, settling server 40 checks the transmitted credit information against the information stored in credit information database 50 to determine whether a credit sale is to be approved or not. If a credit sale is to be approved, then settling server 40 transmits an approval notice to user terminal 30 in step 402.

In step 403, the user operates user terminal 30 to connect to seller server 10, and applies for the purchase of the chosen article together with the transmission of the approval notice given from settling server 40.

In response to the application for the purchase from user terminal 30, seller server 10 confirms the approval notice, then accepts the purchase of the article, and sends a purchase acceptance notice to user terminal 30 in step 404. The article will subsequently be delivered to an address that has been indicated by the user upon the application for the purchase of the article.

The above two conventional network sales systems allow the payment of money for an article to be settled via the network. However, since the network such as the Internet is open to the public, information passing through the network may possibly be known to a third party. If important personal information such as a credit number of the user is stolen for unauthorized use by a third party, then the user may end up being billed for an article that the third party has purchased in the name of the user without the user's recognition.

In recent years, there has been used a process of transmitting and receiving important information over the network after the information has been encrypted. However, it is difficult to completely protect even encrypted information against theft, and the possibility of theft of important personal information of a credit number, etc., cannot fully be eliminated.

### SUMMARY OF THE INVENTION

It is therefore an object of the present invention to provide a network sales system for eliminating the possibility of theft of important personal information of a credit number, etc., for increased security upon settlement of the payment of money for a purchased article over the Internet.

To achieve the above object, there is provided in accordance with an aspect of the present invention a network sales system comprising at least one user terminal, a credit information database, a settling server, an article database, and a seller server.

The user terminal is operated by a user for purchasing an article and connectable to a first network.

The credit information database stores credit information of each user indicative of whether a credit sale is to be approved or not.

The settling server, which is connected to a second network inaccessible from unspecified third parties, checks transmitted credit information, requested to be checked, against the credit information stored in the credit information database to determine whether a credit sale is to be approved or not.

The article database stores information of articles offered for sale.

The seller server, which is connected to the first network and the second network, provides the information of articles offered for sale from the article database to the user terminal via the first network. The seller server requests the settling server via the second network to check credit information if an application for the purchase of an article is received from the user terminal via the first network. The seller server indicates an acceptance of the application for the purchase of the article to the user terminal via the first network if an approval notice is received from the settling server via the second network.

With the above arrangement, important personal information such as a credit number of the user is transmitted and received over only the second network, and the settling server is connected only to the second network. Therefore, the credit information is prevented from being stolen by third parties, and unauthorized third parties are prevented from entering settling server. The network sales system thus has increased security.

According to another aspect of the present invention, the seller server and the settling server of the network sales system may be connected to each other by a dedicated line, rather than the second network.

The above and other objects, features, and advantages of the present invention will become apparent from the following description with reference to the accompanying drawings which illustrate examples of the present invention.

### BRIEF DESCRIPTION OF THE DRAWINGS

FIG. 1 is a block diagram of a conventional network sales system;

FIG. 2 is a sequence chart of operation of the conventional network sales system shown in FIG. 1;

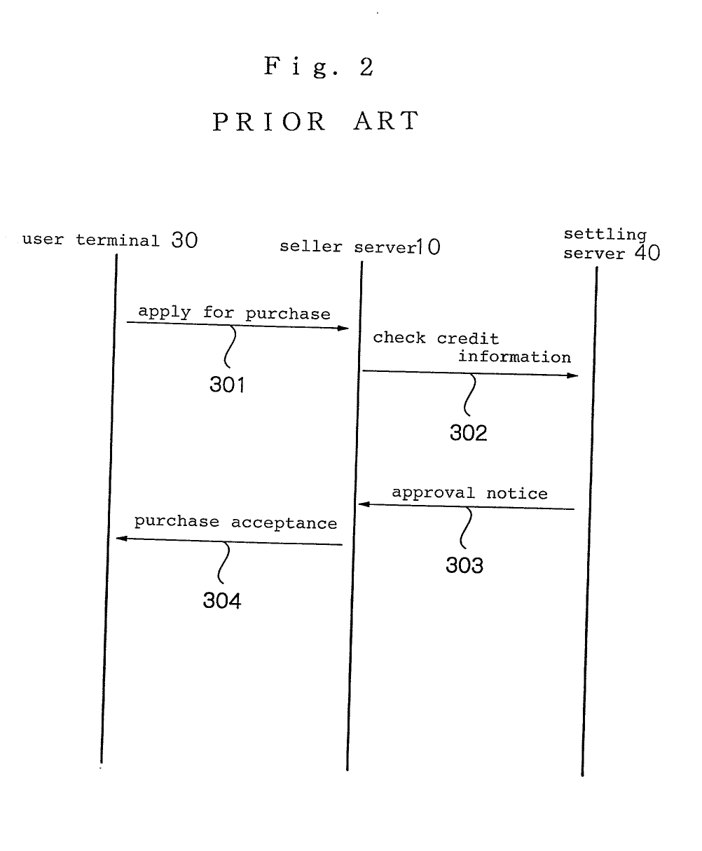

FIG. 3 is a sequence chart of operation of another conventional network sales system;

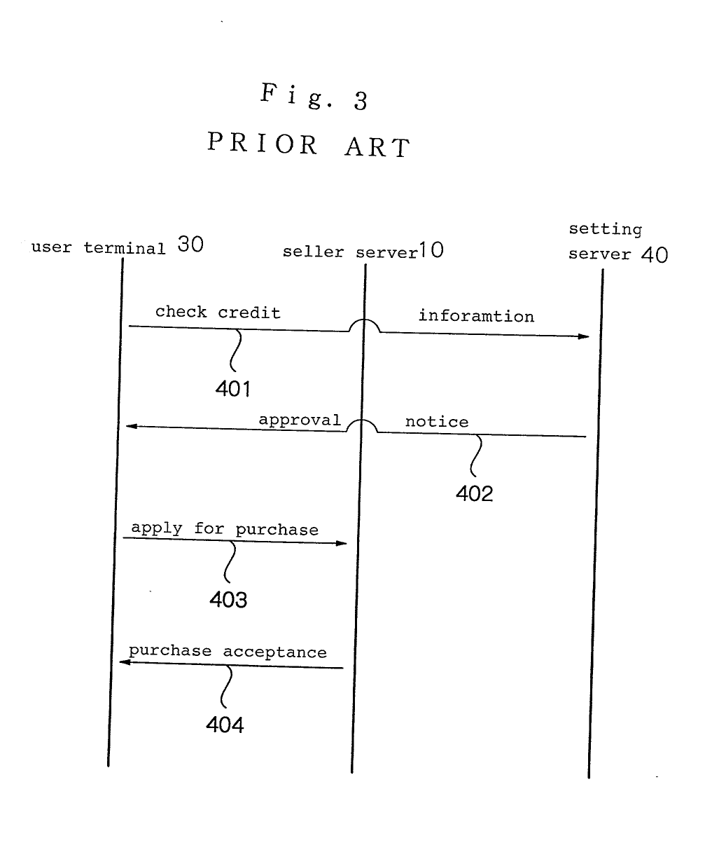

FIG. 4 is a block diagram of a network sales system according to a first embodiment of the present invention;

FIG. 5 is a block diagram of a seller server of the network sales system shown in FIG. 4;

FIG. 6 is a sequence chart of operation of the network sales system shown in FIG. 4; and

FIG. 7 is a block diagram of a network sales system according to a second embodiment of the present invention.

### DETAILED DESCRIPTION OF THE PREFERRED EMBODIMENTS

1st Embodiment

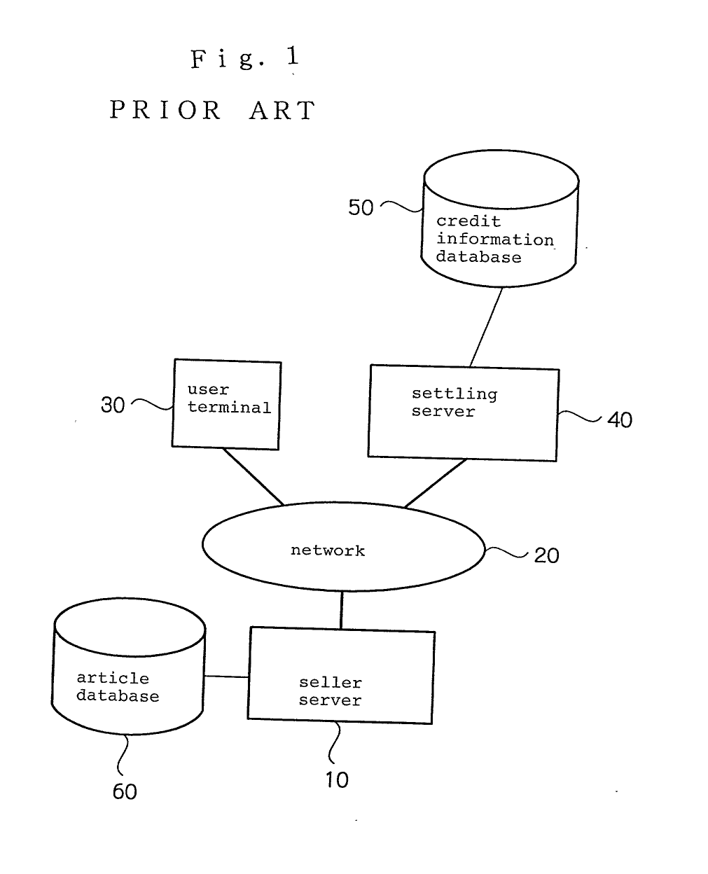

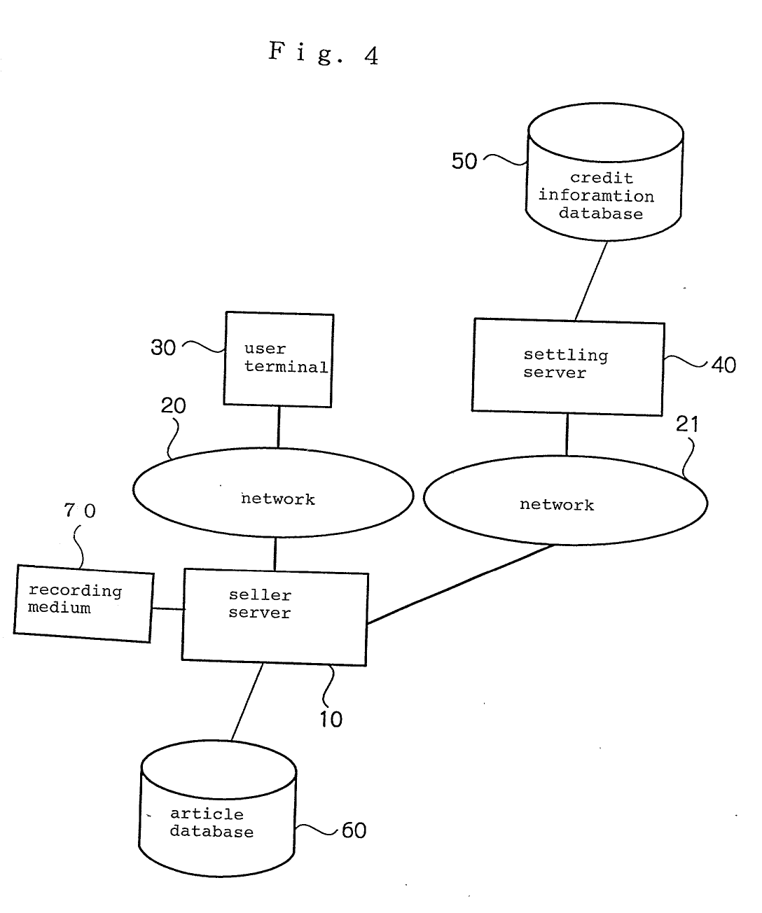

As shown in FIG. 4, a network sales system according to a first embodiment of the present invention comprises seller server 10, networks 20, 21, user terminal 30, settling server 40, credit information database 50, article database 60, and recording medium 70. Those parts of the network sales system shown in FIG. 4 which are identical to those of the network sales system shown in FIG. 1 are denoted by identical reference numerals, and will not be described in detail below. In the present embodiment, user terminal 30 and seller server 10 are connected to each other by network 20, and settling server 40 and seller server 10 are connected to each other by network 21. Network 21 is a closed network that cannot be connected from general user terminals and is inaccessible from unspecified third parties.

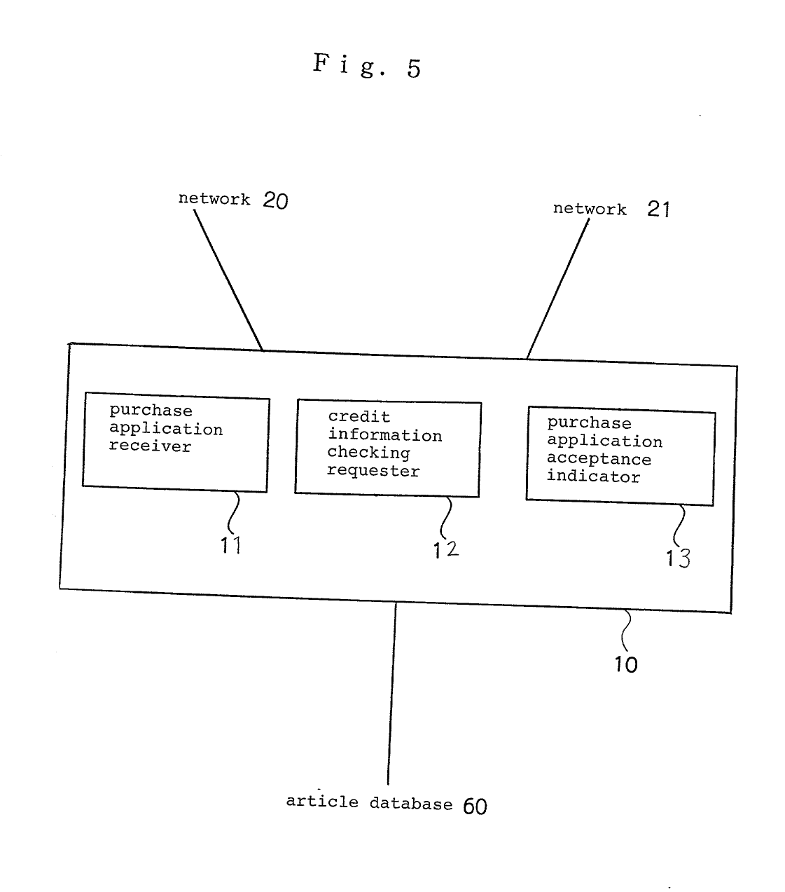

As shown in FIG. 5, seller server 10 comprises purchase application receiver 11, credit information checking requester 12, and purchase application acceptance indicator 13.

Purchase application receiver 11 provides information of articles offered for sale to user terminal 30 via network 20. When an application for the purchase of an article is received from user terminal 30 via network 30, credit information checking requester 12 requests settling server 40 via network 21 to check the credit information. When an approval notice is received from settling server 40 via network 21, purchase application acceptance indicator 13 indicates the acceptance of the application for the purchase of the article to user terminal 30 via network 20.

Recording medium 70 stores a program for carrying out a network sale method according to the present invention. The program is read from recording medium 70 into seller server 10 to control operation of seller server 10. Under the control of the program, seller server 10 performs the processing described below. Recording medium 70 may comprise a magnetic disk, a semiconductor memory, or any of various other recording mediums.

The network sales system may have a backup unit for storing functions of seller server 10, information stored in seller server 10, and information stored in article database 60, credit information database 50, and recording medium 70.

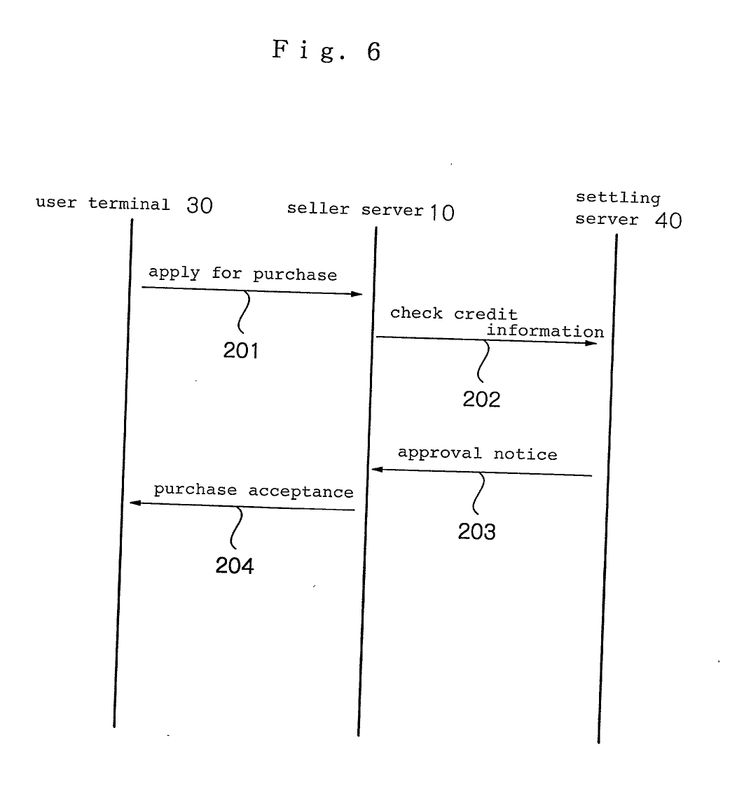

Operation of the network sales system according to the first embodiment will be described below with reference to a sequence chart shown in FIG. 6.

In step 201, the user operates user terminal 30 to connect to seller server 10 via network 20, chooses an article which the user wants to purchase, and applies for the purchase of the chosen article together with the transmission of information indicating the credit number, etc.

In response to the application for the purchase from user terminal 30, seller server 10 transmits information indicating the amount of money to be paid for the article, the name of the user, the credit number, etc., via network 21 to settling server 40 to request settling server 40 to check the credit information in step 202.

Requested by seller server 10 to check the credit information, settling server 40 checks the transmitted credit information against the information stored in credit information database 50 to determine whether a credit sale is to be approved or not. If a credit sale is to be approved, then settling server 40 transmits an approval notice to seller server 10 via network 31 in step 203.

When supplied with the approval notice from settling server 40 via network 21, seller server 10 sends a purchase acceptance notice to user terminal 30 in step 204. The article will subsequently be delivered to an address that has been indicated by the user upon the application for the purchase of the article.

According to the first embodiment, important personal information such as a credit number of the user is transmitted and received over only the network 21 that is not open to unspecified third parties, and settling server 40 is connected only to network 21. Therefore, the credit information is prevented from being stolen by third parties, and unauthorized third parties are prevented from entering settling server 40. The network sales system according to the first embodiment thus has increased security.

2nd Embodiment

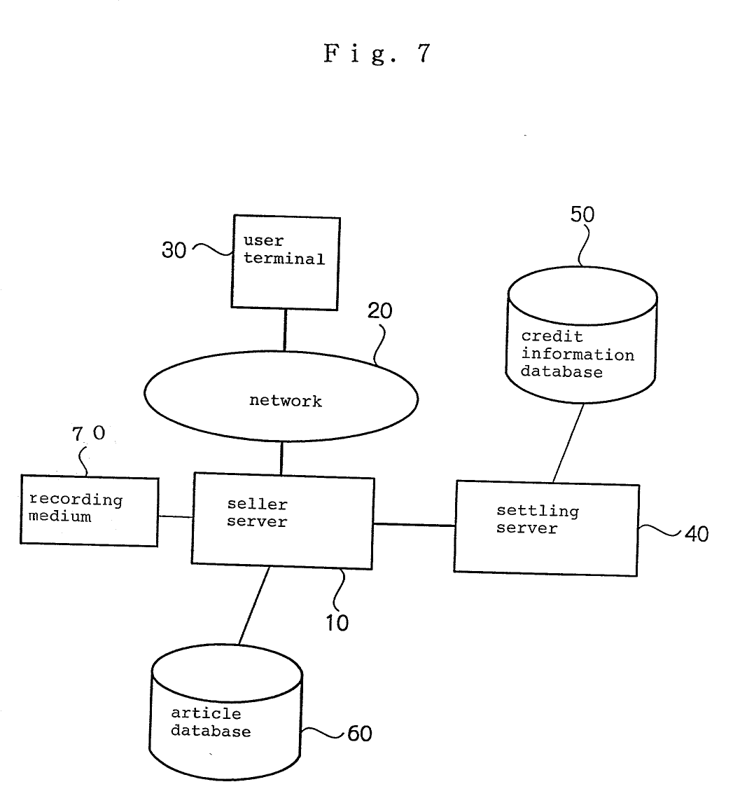

A network sales system according to a second embodiment of the present invention will be described below. FIG. 7 shows in block form the network sales system according to the second embodiment of the present invention. Those parts of the network sales system shown in FIG. 7 which are identical to those of the network sales system shown in FIG. 4 are denoted by identical reference numerals, and will not be described in detail below.

The network sales system according to the second embodiment is similar to the network sales system according to the first embodiment shown in FIG. 4 except that seller server 10 and settling server 40 are connected to each other by a dedicated line. Operation of the network sales system according to the second embodiment is essentially identical to operation of the network sales system according to the first embodiment as shown in FIG. 6, and will not be described in detail below.

With seller server 10 and settling server 40 being connected to each other by a dedicated line, the network sales system according to the second embodiment offers the same advantages as those of the network sales system according to the first embodiment shown in FIG. 4. The network sales system according to the second embodiment has a higher security level than the network sales system according to the first embodiment as the dedicated line interconnecting seller server 10 and settling server 40 makes it more difficult for third parties to enter the network sales system and steal personal information from the network sales system.

While preferred embodiments of the present invention have been described using specific terms, such description is for illustrative purposes only, and it is to be understood that changes and variations may be made without departing from the spirit or scope of the following claims.

What is claimed is:

1. A network sales system comprising:
at least one user terminal operable by a user for purchasing an article and connectable to a first network;
a credit information database for storing credit information of each user indicative of whether a credit sale is to be approved or not;
a settling server connected to a second network inaccessible from unspecified third parties, for checking transmitted credit information, requested to be checked, against the credit information stored in said credit information database to determine whether a credit sale is to be approved or not;
an article database for storing information of articles offered for sale; and
a seller server connected to said first network and said second network, for providing the information of articles offered for sale from said article database to said user terminal via said first network, requesting said settling server via said second network to check credit information if an application for the purchase of an article is received from said user terminal via said first network, and indicating an acceptance of the application for the purchase of the article to said user terminal via said first network if an approval notice is received from said settling server via said second network.

2. A network sales system comprising:
at least one user terminal operable by a user for purchasing an article and connectable to a network;
a credit information database for storing credit information of each user indicative of whether a credit sale is to be approved or not;
a settling server for checking transmitted credit information, requested to be checked, against the credit information stored in said credit information database to determine whether a credit sale is to be approved or not;
an article database for storing information of articles offered for sale; and
a seller server connected to said network and connected to said settling server via a dedicated line, for providing the information of articles offered for sale from said article database to said user terminal via said network, requesting said settling server via said dedicated line to check credit information if an application for the purchase of an article is received from said user terminal via said network, and indicating an acceptance of the application for the purchase of the article to said user terminal via said network if an approval notice is received from said settling server via said dedicated line.

3. A seller server connected to a first network to which there is connected at least one user terminal operable by a user for purchasing an article, and connected to a second network inaccessible from unspecified third parties, comprising:
means for providing the information of articles offered for sale to said user terminal via said first network;
means for requesting a settling server which determines if a credit sale is to be approved or not to check credit information via said second network if an application for the purchase of an article is received from said user terminal via said first network; and
means for indicating an acceptance of the application for the purchase of the article to said user terminal via said first network if an approval notice is received from said settling server via said second network.

4. A seller server connected to a network to which there is connected at least one user terminal operable by a user for purchasing an article, and connected to a dedicated line inaccessible from unspecified third parties, comprising:
means for providing the information of articles offered for sale to said user terminal via said network;
means for requesting a settling server which determines if a credit sale is to be approved or not to check credit information via said dedicated line if an application for the purchase of an article is received from said user terminal via said network; and
means for indicating an acceptance of the application for the purchase of the article to said user terminal via said network if an approval notice is received from said settling server via said dedicated line.

5. A method of selling an article between a user terminal and a seller server which are connected to each other through a first network accessible from unspecified third parties, comprising the steps of:
providing information of articles offered for sale to said user terminal via said first network;
requesting a settling server which determines if a credit sale is to be approved or not to check credit information via a second network inaccessible from unspecified third parties if an application for the purchase of an article is received from said user terminal via said first network; and
indicating an acceptance of the application for the purchase of the article to said user terminal via said first network if an approval notice is received from said settling server via said second network.

6. A method of selling an article between a user terminal and a seller server which are connected to each other through a network accessible from unspecified third parties, comprising the steps of:
providing information of articles offered for sale to said user terminal via said network;
requesting a settling server which determines if a credit sale is to be approved or not to check credit information via a dedicated line inaccessible from unspecified third parties if an application for the purchase of an article is received from said user terminal via said network; and
indicating an acceptance of the application for the purchase of the article to said user terminal via said network if an approval notice is received from said settling server via said dedicated line.

7. A program for enabling a computer to perform a process of selling an article between a user terminal and a seller server which are connected to each other through a first network accessible from unspecified third parties, comprising the steps of:
providing information of articles offered for sale to said user terminal via said first network;
requesting a settling server which determines if a credit sale is to be approved or not to check credit information via a second network inaccessible from unspecified third parties if an application for the purchase of an article is received from said user terminal via said first network; and
indicating an acceptance of the application for the purchase of the article to said user terminal via said first network if an approval notice is received from said settling server via said second network.

8. A program for enabling a computer to perform a process of selling an article between a user terminal and a seller server which are connected to each other through a network accessible from unspecified third parties, comprising the steps of:
providing information of articles offered for sale to said user terminal via said network;
requesting a settling server which determines if a credit sale is to be approved or not to check credit information via a dedicated line inaccessible from unspecified third parties if an application for the purchase of an article is received from said user terminal via said network; and
indicating an acceptance of the application for the purchase of the article to said user terminal via said network if an approval notice is received from said settling server via said dedicated line.
